(19) United States
(12) Patent Application Publication
(10) Pub. No.: US 2011/0106797 A1
(43) Pub. Date: May 5, 2011

(54) DOCUMENT RELEVANCY OPERATOR

(75) Inventors: Ravi K. PALAKODETY, Redwood City, CA (US); Wesley C. Lin, West Covina, CA (US); Sachin Bhatkar, Sunnyvale, CA (US); Jeongwoo Ko, Palo Alto, CA (US); Thomas Chang, Foster City, CA (US); Mohammad Faisal, Belmont, CA (US)

(73) Assignee: ORACLE INTERNATIONAL CORPORATION, Redwood Shores, CA (US)

(21) Appl. No.: 12/610,606

(22) Filed: Nov. 2, 2009

(51) Int. Cl. G06F 17/30

(52) U.S. Cl. 707/728; 707/780; 707/E17.008; 707/E17.014

(57) ABSTRACT

Systems, methods, and other embodiments associated with document relevancy are described. One example method includes receiving one or more query terms from a query on stored documents. A relevancy operator is run on a document clump that applies more than one type of matching operation between the query terms and the document clump in a single pass. The relevancy operator may also apply at least one heuristic on the document clump in a single pass. A document's relevancy to the query is predicted based, at least in part, on an output of the relevancy operator.

### BACKGROUND

When a user runs an Internet search for web pages that are relevant to a query, the query terms are received and processed by a search engine. In response to the query, the search engine runs different types of matching operations on various web pages by rewriting the query into a set of queries that apply different types of matching operations to the web page and query terms. For example, some matching operations determine if a web page includes query terms from the query within various levels of proximity to one another. Each of these different types of matching operations is performed in a separate processing pass. Results of the matching operations are used to select web pages to present as search results to the user. In an enterprise search system, heuristics are also used to better predict a web page's relevance to a query. The results of the matching operations and heuristics for a particular web page are normalized and combined to rank the web page according to its predicted relevance.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example embodiment of a computing system for processing a query on stored documents.

FIG. 2 illustrates an example embodiment of a computing system for processing a query on stored documents.

FIG. 3 illustrates an example embodiment of a computing system, inverted index, and rank order list.

FIG. 4 illustrates an example embodiment of a method for predicting a document's relevancy to a query.

FIG. 5 illustrates an example embodiment of a method for predicting a document's relevancy to a query.

FIG. 6 illustrates an example embodiment of a method for predicting a document's relevancy to a query.

FIG. 7 illustrates an example embodiment of a method for predicting a document's relevancy to a query.

FIG. 8 illustrates an example embodiment of a method for predicting a document's relevancy to a query.

FIG. 9 illustrates an example computing environment in which example systems and methods, and equivalents, may operate.

### DETAILED DESCRIPTION

Described herein are example systems, methods, and other embodiments associated with using a relevancy operator to predict a document's relevancy to a query. Typically, a user enters query terms and the search is performed on a stored document set based on the query terms. To predict a relevancy of documents to the query, the relevancy operator performs different types of matching operations between the documents and the query terms. These different types of matching operations are run by the relevancy operator in a single pass.

Example matching operations may include PHRASE match (e.g., an exact phrase is present in a document), NEAR match (e.g., search terms are within a user-defined number of words), and others. In one embodiment, PHRASE match and NEAR match are run in a single pass. Results from running PHRASE match and NEAR match are used to predict a relevancy of a document with respect to the search. Computer operation costs and response time may be reduced by performing multiple types of matching operations on a document in a single pass.

In addition to performing multiple types of matching operations during a single pass, the relevancy operator may include multiple heuristics that are evaluated during a single pass. The heuristics attempt to quantify an importance of a match with respect to the query terms. For example, a match located in an introduction paragraph may be considered more important than a match located in a footnote. A result from evaluating the heuristic is combined with a result of performing the matching operation to produce a relevancy operator output. The output is indicative of a predicted relevancy for the document.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

The following are definitions of acronyms used herein: ASIC (application specific integrated circuit), CD (compact disk), CD-R (CD recordable), CD-RW (CD rewriteable), DVD (digital versatile disk) and/or (digital video disk), LAN (local area network), PCI (peripheral component interconnect), PCIE (PCI express), RAM (random access memory), DRAM (dynamic RAM), SRAM (synchronous RAM.), ROM (read only memory), PROM (programmable ROM), SQL (structured query language), OQL (object query language), USB (universal serial bus), WAN (wide area network).

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

“Query”, as used herein, refers to a semantic construction that facilitates gathering and processing information. A query may be formulated in a database query language (e.g., SQL), an OQL, a natural language, and so on.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instructions stored on a computer-readable medium that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

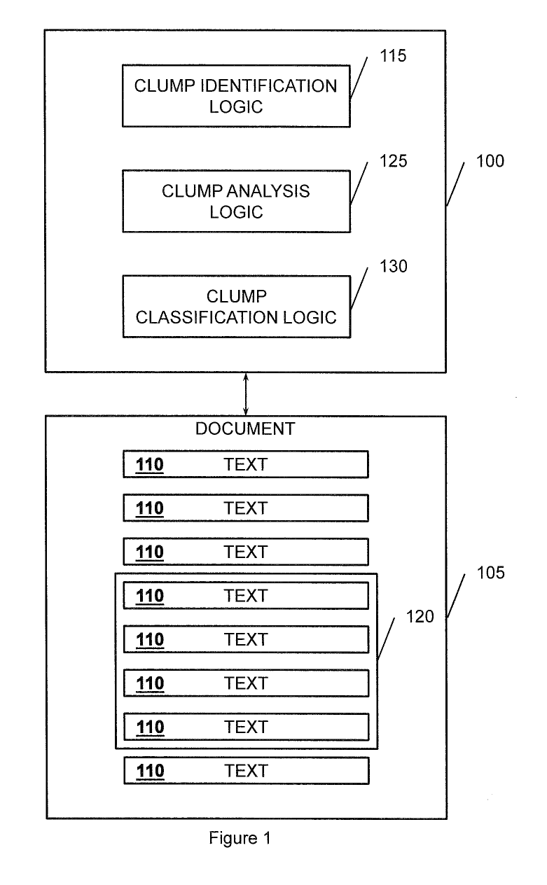

FIG. 1 illustrates one example embodiment of a computing system 100 for processing a query on a set of stored documents that includes a document 105. The document 105 includes multiple text portions 110. The computing system 100 processes queries to search for relevant documents based on query terms. The computing system 100 evaluates the document 105 with regard to the query terms by evaluating the text portions 110 to determine if any of the text portions 110 includes the query terms. In general, a document that includes the query terms is predicted to be more relevant than a document that does not include the query terms.

The computing system 100 includes a clump identification logic 115, a clump analysis logic 125, and a clump classification logic 130. The clump identification logic 115 identifies a document clump 120. The document clump 120 comprises a portion of the document 105 that includes one or more of the query terms. In one embodiment, the document clump 120 includes all query terms. The document clump 120 is evaluated to predict how relevant the overall document 105 is to the query.

The clump analysis logic 125 runs a relevancy operator on the document clump 120. The relevancy operator applies more than one type of matching operation between the query terms and the document clump 120 in a single pass. The clump classification logic 130 classifies the document clump 120 based, at least in part, on a result of the matching operations. In one example, the matching operations may conclude that query terms are exactly matched in the document clump 120. Based on the exact match, the document clump 120 may be classified as an exact match clump. The clump classification of the document clump 120 may be used in predicting a relevance of the overall document 105 to the query and to rank the document against other documents.

The relevancy operator may also apply more than one clump heuristic to the document clump 120. In this case, the clump classification logic 130 determines a document score based, at least in part, on both a result of the matching operations and the clump heuristics. The relevancy operator may apply the clump heuristic to the document clump in the same pass used to perform the matching operations. The document score is used to rank the document among other documents based on its predicted relevancy to the query terms.

In one embodiment, documents are processed one-by-one. In one embodiment, an inverted index is used to facilitate determining the relevancy of multiple documents in a single processing pass. In this embodiment, the system 100 accesses an inverted index to locate documents that satisfy the query. The inverted index returns an identity of documents that include the query terms as well as the positions of the query terms in those documents. Using information returned by the inverted index, the system 100 may then perform clump identification, clump analysis, clump classification, clump heuristics, and so on in a single pass.

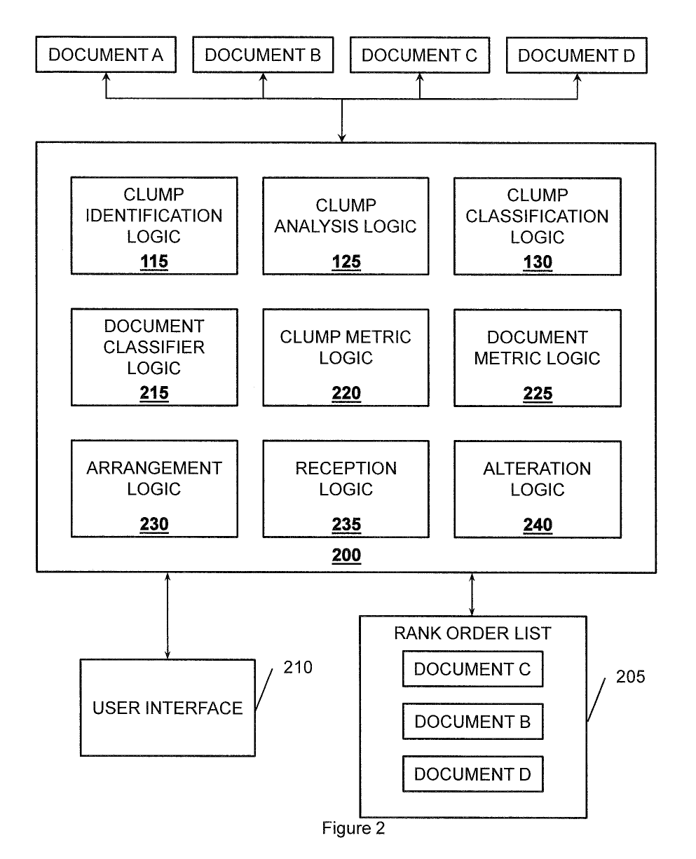

FIG. 2 illustrates one embodiment of a computing system 200 for producing a rank order list 205. The rank order list 205 may present documents in an order of predicted relevancy to query terms. In one embodiment, the rank order list 205 may be presented through a user interface 210. In addition, query terms may be entered via the user interface 210. Documents are evaluated by the computing system 200 to predict their relevancy to the search terms. In one example, the computing system 200 operates in an enterprise search environment. The illustrated enterprise search environment includes four documents: documents A, B, C, and D. The computing system 200 evaluates the four documents to predict a document relevancy for each document with respect to the query terms and presents the rank order list 205 which identifies document C as being more relevant than document B and so on.

The clump identification logic 115 identifies a document clump in a document that contains one or more of the query terms. A clump analysis logic 125 runs a relevancy operator on the clump that applies more than one type of matching operation to the document clump and the query terms. The clump classification logic 130 classifies the clump based, at least in part, on a result of the matching operations. In one embodiment, the logics 115, 125, and 130 reiterate operation until all clumps of a document are identified and classified.

A document classifier logic 215 classifies the document based, at least in part, on clump classifications of document clumps in the document. In one example, a document has two clumps. The first clump is classified as a PHRASE match (e.g., the exact search terms are found in order and together). The second clump is classified as an ORDERED NEAR match (e.g., the exact search terms are found in order and in one sentence, but not together). These clump classifications can be aggregated so the document has a classification of one PHRASE and one ORDERED NEAR.

The clump analysis logic 125 also applies a superheuristic that includes one or more heuristics to the document clump. The relevancy operator may apply the more than one matching operations and the superheuristic to the document clump in the same single pass. A clump metric logic 220 determines a clump score based, at least in part, on a result of the superheuristic. The superheuristic may include heuristics such as a clump start position, a clump excess span, a number of query children, a length of longest partial phrase in clump, and others. A heuristic equation is used by the clump metric logic 220 to weight results from the various heuristics in the superheuristic. For example, the equation may more heavily weight clump start position than largest partial phrase. The clump score may be derived from the equation result and provides for diminishing returns.

A document metric logic 225 aggregates clump scores to form a document heuristic result. The document heuristic result and document classification may be combined to generate an overall document score used in ranking documents against one another. An arrangement logic 230 ranks the documents according to the document score and creates the rank order list 205.

In one embodiment, the arrangement logic 230 ranks the documents based, at least in part, on the document classification. For instance, a document with a three PHRASE classification might be ranked higher than a two PHRASE classification document. Thus, a different classifications may be given different weights. For instance, a document with a classification of five NEAR ORDERED may be ranked higher than a one PHRASE classification document, but lower than a two PHRASE classification document. How ranking occurs may be programmed through the user interface, be hard-coded, be used with a default setting, and so on.

In another embodiment, the document score combines the document classification and the document heuristic result so that the documents are ranked based, at least in part, on both the document classification and the document heuristic result. In one embodiment, the document ranking is first based on the document classification. The document heuristic result is then used to break a tie between documents with a similar and/or equal document classification. The arrangement logic 230 produces a rank order list 205 based on the document scores.

A user may desire to change how the documents are scored or ranked. The user may use the user interface 210 to supply a modification instruction. A reception logic 235 collects the modification instruction. An alteration logic 240 makes a modification to the ranking method according to the collected modification instruction. The modification can thus be made to the relevancy operator to change a method used to rank documents in the rank order list 205 or the heuristic equation used to produce the clump score.

The modification instruction may comprise an instruction to delete a relevancy heuristic from the superheuristic. The modification instruction may also comprise an instruction to add a relevancy heuristic to the superheuristic. In addition, the modification instruction may comprise an instruction to alter a relevancy heuristic of the superheuristic. Other modification instructions may include changing a relative weight as between the various matching operation results, adding a matching operation, and others. Therefore, a user may modify how the rank order list 205 is produced by providing a modification instruction.

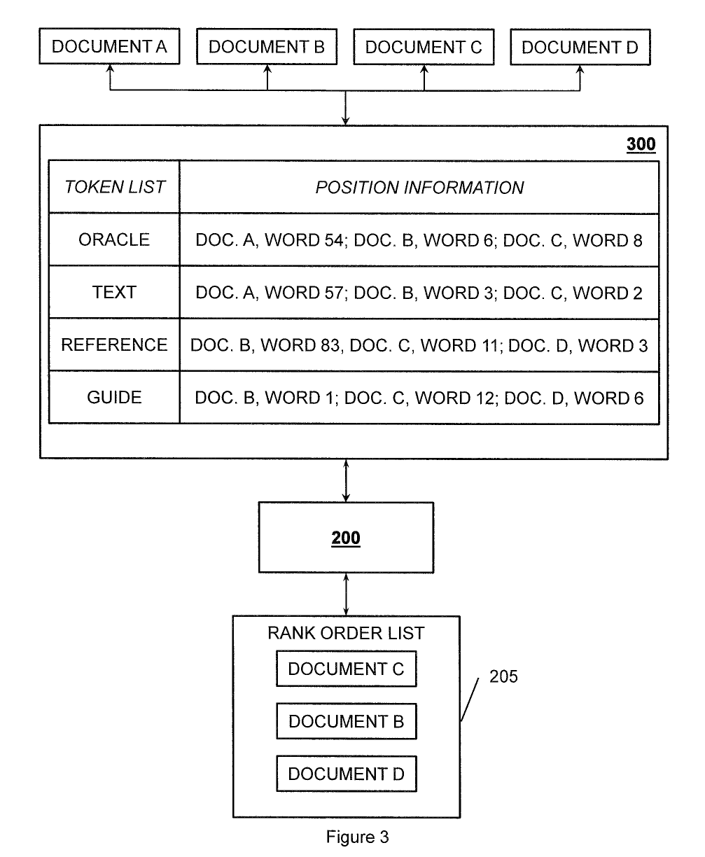

FIG. 3 illustrates one embodiment of a computing system 200 using a document relevancy operator on document information provided by an inverted index 300. The system 200 queries the inverted index 300 for documents that include one or more query terms. In response, the inverted index 300 provides a list of the query terms (identified in 300 as “tokens”) as well as position information for each query term in each document that includes the query. The position information is used by the relevancy operator in the computing system 200 to determine document relevancy for multiple documents in a single pass.

In the example illustrated in FIG. 3, documents A-D are available for searching. The inverted index 300 maps words and other textual elements that are present in documents A-D to their position within the documents. The system 200 performs a search for “Oracle Text Reference Guide.” The relevant portions of the inverted index 300 are shown in FIG. 3, depicting tokens (e.g., query children) for Oracle, Text, Reference, and Guide.

The system 200 accesses the index 300 for position information for the individual words. Based on the position information, the relevancy operator determines a relative relevance of the documents and produces a rank order list 205. Documents B and C include all the query terms. However, Document C has a shorter span between the four query terms (Document C has all of the query terms between words 2-12 while Document B has all of the query terms between words 3-83). Further, Document C has two query terms next to each other and in order (“Reference” at word 11 and “Guide” at word 12). Thus, the various types of matching operations such as exact, near, and so on may be ascertained by running a relevancy operator in a single pass.

In the illustrated example Document C has a higher clump score than Document B based on the matching operations. Thus, Document C may be considered more relevant and be ranked first while Document B is ranked second in the rank order list 205. Documents A and D contain two query terms (A has “Oracle” at word 54 and “Text” at word 57 while D has “Reference” at word 3 and “Guide” at word 6”). While documents A and D would have similar matching operation results, Document D is ranked third ahead of A. This ordering as between documents with similar matching operation results is the result of heuristics. For example, a heuristic may be applied that ranks documents having a match position earlier in the document before documents that have a match position later in the document. Document A may not be ranked because a heuristic may exist that specifies that the rank order list 205 should list no more than three documents. Any number of heuristics may be employed by the relevancy operator in determining document relevancy. The heuristics can be applied using the information in the inverted index in the same pass as the matching operations.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

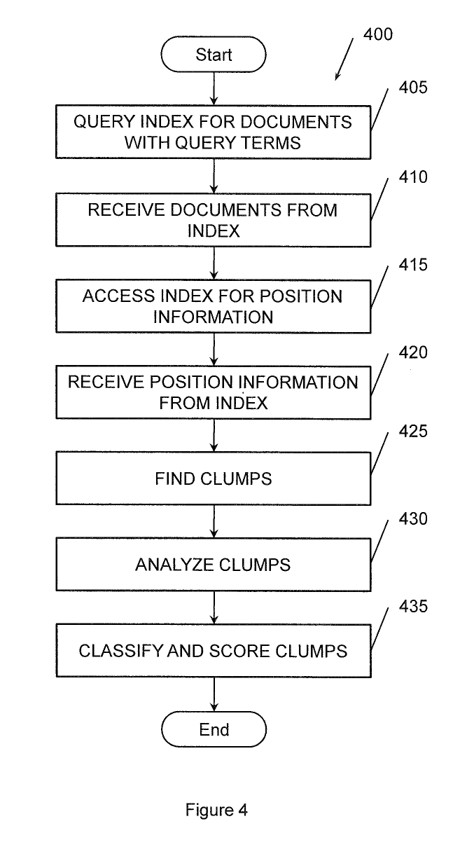

FIG. 4 illustrates one embodiment of a method 400 for using an inverted index to score and/or classify a document. A user enters query terms. At 405 a query is made to an inverted index for documents that contain the query terms. In one embodiment, when entering the query terms, the user designates a document set to be searched. At 410, the identities of a set of documents containing one or more query terms is received.

At 415, an inverted index is accessed to determine position information for query terms within the identified documents. The inverted index may be the same inverted index accessed in 405 or may be one or more different inverted indexes that summarize information for one or more documents in the identified set of documents. At 420, the position information is received. At 425, clumps are found based, at least in part, on the position information. At 430, the clumps are analyzed. At 435, the clumps are scored and classified. Based, at least in part, on clump scoring and/or classification, documents may be scored and/or classified. Documents are ranked to produce a document rank list.

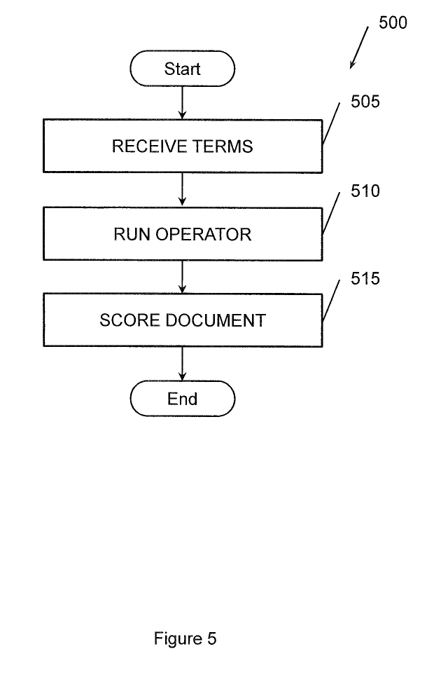

FIG. 5 illustrates one embodiment of a method 500 for predicting a document relevancy to a query. At 505, one or more query terms are received from a query on stored documents. The relevancy operator is run on an identified document clump within a document at 510. The document clump is a portion of the document that includes one or more of the query terms. The relevancy operator applies more than one type of matching operation between the query terms and the clump in a single pass. At 515, the document is scored based, at least in part, on a result from application of the matching operations. For example, results of the matching operations on different clumps of a document might be aggregated to produce a document score. This document score can be used to rank the document against other documents according to their predicted relevance to the query.

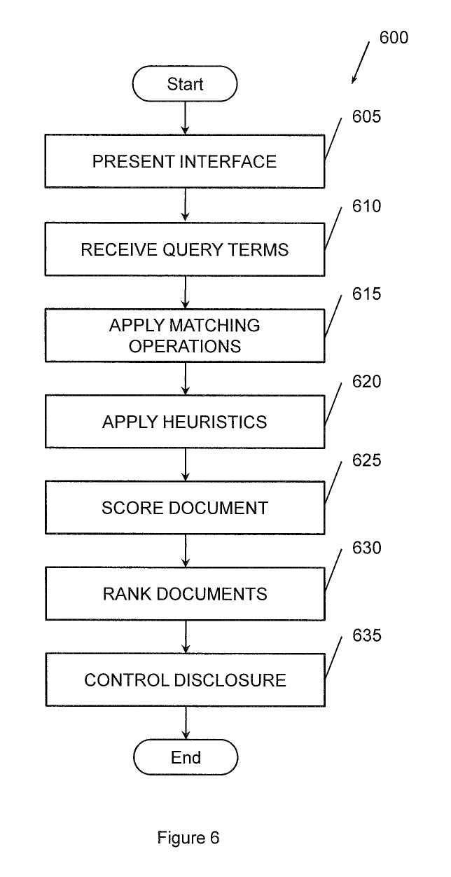

FIG. 6 illustrates one embodiment of a method 600 for ranking documents according to their predicted relevancy to the query. A user may submit a query on documents in a database system. In one embodiment, the database system is an enterprise system and the documents are text files. In another embodiment, the database system is the Internet and the documents are web pages.

At 605, the user is presented with a user interface. The user enters query terms through the user interface. These query terms are received at 610. The user interface may also enable the user to modify at least one scoring parameter used to weight intermediate results, such as between different types of matching operations or heuristics, within the relevancy operator.

At 615 document clumps are located within the documents and a relevancy operator that applies more than one type of matching operation between the query terms and the clump in a single pass is performed on the document clumps. The relevancy operator also applies more than one type of heuristic to the clump at 620.

At 625, each document is scored based, at least in part, on an output of the relevancy operator. Scoring the document may be performed by aggregating results of matching operations document clumps in the document. The document score may also be based, at least in part, on an aggregation of results of the heuristics. A document is ranked against at least one other document based, at least in part, on the document score at 630. The user interface is controlled to disclose a ranked document rank list to the user at 635.

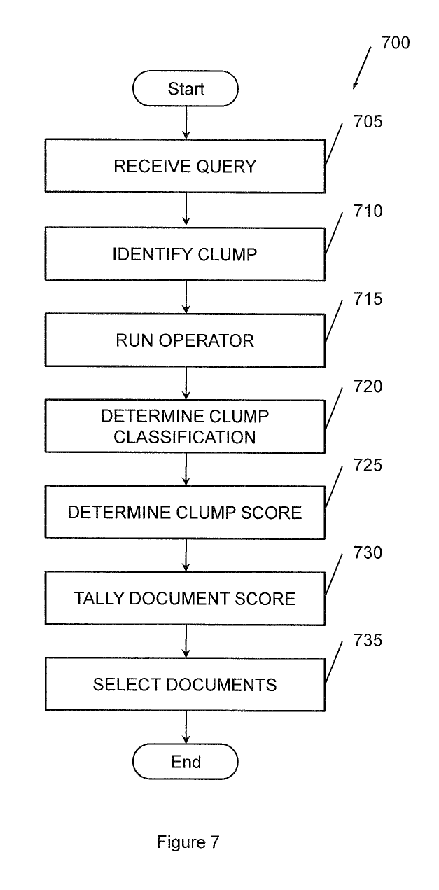

FIG. 7 illustrates one example embodiment of a method 700 for selecting documents for presentation based on a predicted document relevancy. At 705, a query is received that seeks to identify documents relevant to one or more query terms in the query. A document clump in a document is identified at 710. A relevancy operator is run on the document clump at 715. The relevancy operator applies more than one type of matching operation between the query terms and the document clump in a single pass. In addition, the relevancy operator applies at least one clump heuristic to the document clump in a single pass. In one embodiment, the matching operations and clump heuristic are run in the same single pass.

A clump classification is determined based, at least in part, on results of the matching operations at block 720. In addition a clump score for the clump is determined based, at least in part, on results of the at least one clump heuristic at 725. A document score is tallied that includes the clump classification and the clump score at 730. Documents to identify in response to the query are selected based, at least in part, on the document score at block 735.

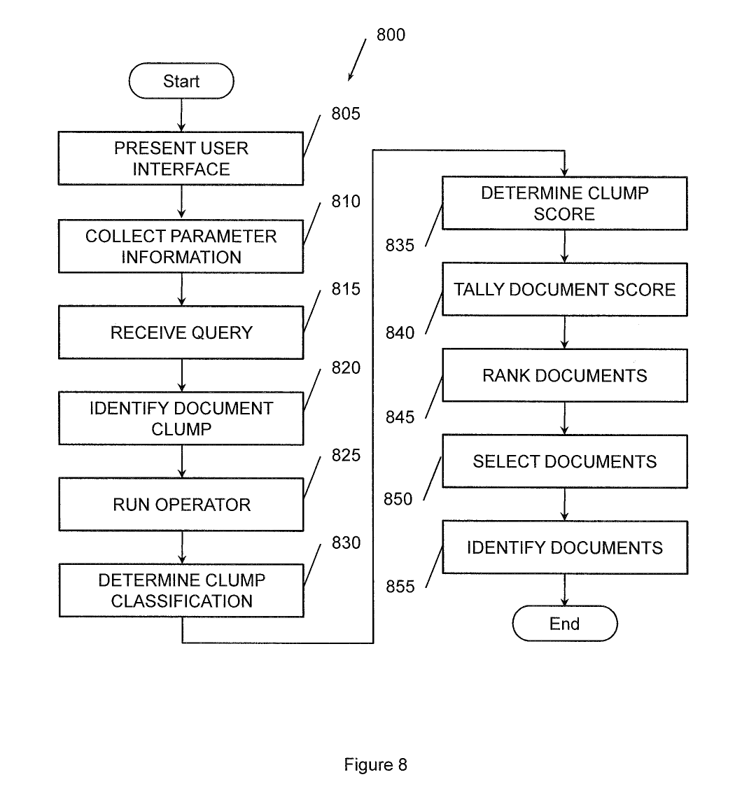

FIG. 8 illustrates one embodiment of a method 800 for processing a query. At 805, a user is presented with a user interface. The user interface enables the user to submit a query on a set of documents. At 810, the user interface may also be used to collect scoring parameter information from a user.

The user's query is received at 815. At 820, a document clump is identified that comprises a portion of the document that includes one or more of the query terms from the query. A relevancy operator is run on the clump at block 825. The relevancy operator applies more than one type of matching operation between the query terms and the clump in a single pass. The matching operations of the relevancy operator may include a PHRASE match, a PARTIAL PHRASE match, an ORDERED NEAR match, an UNORDERED NEAR match, and/or an AND match. The relevancy operator also applies at least one clump heuristic to the document clump in a single pass. The at least one clump heuristic may comprise a clump start position, a clump excess span, a number of query children, and a length of longest partial phrase in clump. Therefore, matching operations and clump heuristics are applied by the relevancy operator to a document clump.

At 830, a clump classification is determined for the document clump based, at least in part, on results of the matching operations. A clump score is also determined for the document clump based, at least in part, on results of the at least one clump heuristic at 835. A document score is tallied that includes the clump classification and the clump score at 840. Tallying the document score may comprise aggregating clump classifications and clump scores of the document. In one embodiment, the document score includes a document classification and a document heuristic result that corresponds to the aggregated clump scores.

At 845, the document is ranked against at least one other document according to the document scores of the document and the document scores of the other document. Documents are selected to identify in response to the query based on document rank at 850. The user interface is controlled to identify the selected documents at 855.

In one example, a method may be implemented as computer executable instructions. Thus, in one example, a computer-readable medium may store computer executable instructions that if executed by a machine (e.g., processor) cause the machine to perform a method such as the methods 700 (FIG. 7) and/or 800 (FIG. 8). In addition, it is to be appreciated that methods disclosed herein may function as computer-implemented methods.

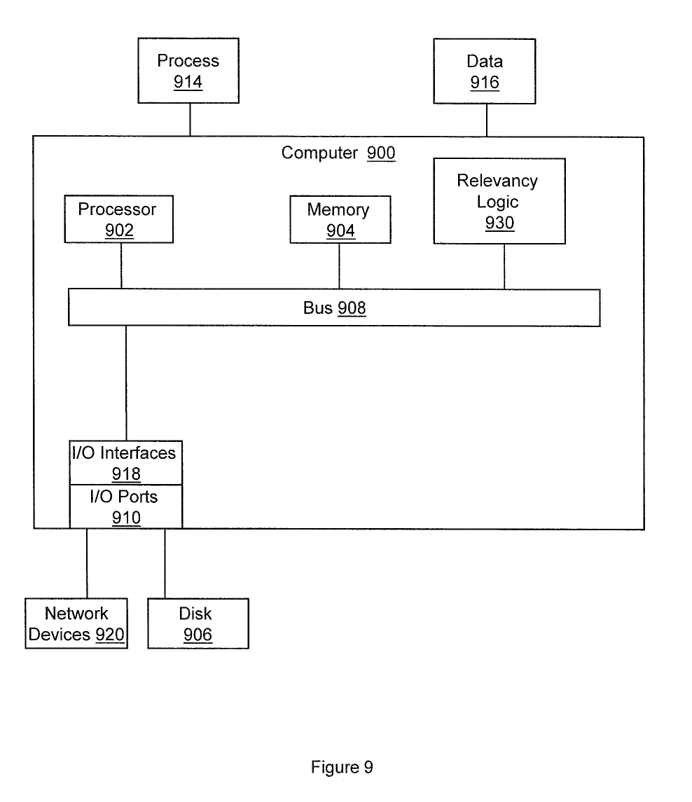

FIG. 9 illustrates an example computing device in which example systems and methods described herein, and equivalents, may operate. The example computing device may be a computer 900 that includes a processor 902, a memory 904, and input/output ports 910 operably connected by a bus 908. In one example, the computer 900 may include a relevancy logic 930 configured to predict a document's relevancy to a query. In different examples, the relevancy logic 930 may be implemented in hardware, software in execution on a processor, firmware, and/or combinations thereof. While the relevancy logic 930 is illustrated as a hardware component attached to the bus 908, it is to be appreciated that in one example, the relevancy logic 930 could be implemented in the processor 902.

Thus, relevancy logic 930 may function as the various logic combinations disclosed in FIG. 1 and/or FIG. 2. The relevancy logic 930 may be implemented, for example, as an ASIC. The relevancy logic 930 may also be implemented as computer executable instructions that are presented to computer 900 as data 916 that are temporarily stored in memory 904 and then executed by processor 902.

Thus, relevancy logic 930 may provide means (e.g., hardware, software, firmware) for running a relevancy operator that applies more than one type of matching operation and at least one heuristic on a document clump in a single pass.

The means may be implemented, for example, as an ASIC programmed to run the relevancy operator. The means may also be implemented as computer executable instructions that are presented to computer 900 as data 916 that are temporarily stored in memory 904 and then executed by processor 902.

Relevancy logic 930 may also provide means (e.g., hardware, software in execution on a processor, firmware) for predicting a relevancy of the document to the query based, at least in part, on an output of the relevancy operator.

Generally describing an example configuration of the computer 900, the processor 902 may be a variety of various processors including dual microprocessor and other multi-processor architectures. A memory 904 may include volatile memory and/or non-volatile memory. Non-volatile memory may include, for example, ROM or PROM. Volatile memory may include, for example, RAM, SRAM, and DRAM.

A disk 906 may be operably connected to the computer 900 via, for example, an input/output interface (e.g., card, device) 918 and an input/output port 910. The disk 906 may be, for example, a magnetic disk drive, a solid state disk drive, a floppy disk drive, a tape drive, a Zip drive, a flash memory card, and a memory stick. Furthermore, the disk 906 may be a CD-ROM drive, a CD-R drive, a CD-RW drive, a DVD ROM drive, a Blu-Ray drive, and an HD-DVD drive. The memory 904 can store a process 914 and/or a data 916, for example. The disk 906 and/or the memory 904 can store an operating system that controls and allocates resources of the computer 900.

The bus 908 may be a single internal bus interconnect architecture and/or other bus or mesh architectures. While a single bus is illustrated, it is to be appreciated that the computer 900 may communicate with various devices, logics, and peripherals using other busses (e.g., PCIE, 1394, USB, Ethernet). The bus 908 can be types including, for example, a memory bus, a memory controller, a peripheral bus, an external bus, a crossbar switch, and/or a local bus.

The computer 900 may interact with input/output devices via the i/o interfaces 918 and the input/output ports 910. Input/output devices may be, for example, a keyboard, a microphone, a pointing and selection device, cameras, video cards, displays, the disk 906, and the network devices 920. The input/output ports 910 may include, for example, serial ports, parallel ports, and USB ports.

The computer 900 can operate in a network environment and thus may be connected to the network devices 920 via the i/o interfaces 918, and/or the i/o ports 910. Through the network devices 920, the computer 900 may interact with a network. Through the network, the computer 900 may be logically connected to remote computers. Networks with which the computer 900 may interact include, but are not limited to, a LAN, a WAN, and other networks.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-implemented method comprising:
receiving one or more query terms from a query on stored documents;
identifying a document clump in the document that includes one or more of the query terms;
running a relevancy operator on the document clump, where the relevancy operator applies more than one type of matching operation between the query terms and the document clump in a single pass; and
determining a document score based, at least in part, on a result of the matching operations, where the document score is used to select one or more documents in response to the query.

2. The computer-implemented method of claim 1 where the relevancy operator applies at least one type of heuristic to the document clump and determines a clump score based, at least in part, on a result of the heuristics and further where the document score is determined, at least in part, on the clump score.

3. The computer-implemented method of claim 1 comprising ranking the document against at least one other document based, at least in part, on the document score.

4. The computer-implemented method of claim 1 comprising presenting a user interface that enables a user to modify a scoring parameter used to weight results of the more than one type of matching operation.

5. The computer-implemented method of claim 1 where determining the document score comprises aggregating results of the matching operations for document clumps in the document.

6. A computing system comprising:
a clump identification logic to identify a document clump comprising a portion of a document that includes one or more query terms in a query on stored documents;
a clump analysis logic configured to run a relevancy operator on the document clump that applies more than one type of matching operation between the query terms and the document clump in a single pass; and
a clump classification logic to determine a clump classification for the document clump based, at least in part, on the results of the matching operations.

7. The computing system of claim 6 comprising a document classifier logic to determine a document classification based, at least in part, on clump classifications for document clumps in the document.

8. The computing system of claim 7 comprising an arrangement logic that orders the document against other documents based, at least in part, on the document classification for the document and a document classification for the other documents.

9. The computing system of claim 6 where the relevancy operator applies a superheuristic that includes more than one type of relevancy heuristic to the document clump in a single pass.

10. The computing system of claim 9 comprising:
a reception logic configured to collect a modification instruction, where the modification instruction comprises at least one of an instruction to delete a relevancy heuristic from the superheuristic, an instruction to add a relevancy heuristic to the superheuristic, or an instruction to alter a relevancy heuristic of the superheuristic; and
an alteration logic configured to modify the superheuristic according to the collected modification instruction.

11. The computing system of claim 9 comprising:
a clump metric logic to determine a clump score based, at least in part, on a result of the superheuristic; and
a document metric logic to aggregate clump scores into a document heuristic result.

12. The computing system of claim 11 comprising:
an arrangement logic that ranks the document against other documents based, at least in part, on the document classification and the document heuristic result of the document and a document classification and a document heuristic result of the other documents, where the ordering is first based on document classification and the document heuristic result is used to break a tie between documents with a similar document classification.

13. The computer system of claim 9 where the superheuristic and the matching operations are run in the same single pass.

14. The computer system of claim 9 where the clump identification logic identifies a document clump based, at least in part, on query term position information provided by an inverted index.

15. A computer-readable medium storing computer-executable instructions that when executed by a computer cause the computer to perform a method, the method comprising:
receiving a query to identify documents relevant to one or more query terms in the query;
identifying a document clump comprising a portion of a document that includes one or more of the query terms;
running a relevancy operator on the document clump that applies more than one type of matching operation between the query terms and the document clump and at least one clump heuristic to the document clump in a single pass;
determining a clump classification based, at least in part, on results of the matching operations;
determining a clump score for the clump based, at least in part, on results of the at least one clump heuristic;
tallying a document score that includes the clump classification and the clump score for document clumps in the document; and
selecting documents to identify in response to the query based, at least in part, on the document score.

16. The computer-readable medium of claim 15, the method comprising ranking the document against at least one other document according to the document score of the document and a document score of the at least one other document.

17. The computer-readable medium of claim 15 where tallying the document score comprises aggregating clump classifications and clump scores for document clumps in the document.

18. The computer-readable medium of claim 15, the method comprising:
controlling a user interface to be presented, where the query is received through the user interface; and
controlling the user interface to identify the selected documents.

19. The computer-readable medium of claim 15, the method comprising collecting scoring parameter information from a user, where the scoring parameter information is used to determine relative weighting between results of the at least one heuristic.

20. The computer-readable medium of claim 15 where the matching operations comprise at least one of a PHRASE match, a PARTIAL PHRASE match, an ORDERED NEAR match, an UNORDERED NEAR match, or an AND match.

21. The computer-readable medium of claim 15 where the at least one clump heuristic comprises at least one of a clump start position, a clump excess span, a number of query children, and a length of longest partial phrase in the document clump.

22. The computer-readable medium of claim 15 where the query is received on an enterprise system.

23. The computer-readable medium of claim 15 where the relevancy operator applies the more than one type of matching operation concurrently with the at least one clump heuristic.

24. The computer-readable medium of claim 15, the method comprising:
querying an inverted index for documents relevant to one or more query terms in response to receiving the query;
receiving documents from the inverted index in response to querying the inverted index; and
accessing the inverted index for query term position information in received documents, where the document clump is identified based, at least in part, on the query term position information.

25. A system, comprising:
means for running a relevancy operator on a document clump, where the relevancy operator applies more than one type of matching operation between query terms in a query and the clump and applies more than one clump heuristic to the clump in a single pass; and
means for predicting a relevancy of the document to the query based, at least in part, on an output of the relevancy operator.
